(19) United States
(12) Patent Application Publication
(10) Pub. No.: US 2014/0196662 A1
(43) Pub. Date: Jul. 17, 2014

(54) Nanoclad Pipe Weld Repair, Systems and Methods

(71) Applicant: FLUOR TECHNOLOGIES CORPORATION, Aliso Viejo, CA (US)

(72) Inventors: Robert Prieto, Princeton Junction, NJ (US); Lakshmanan Rajagopalan, New Delhi (IN)

(73) Assignee: FLUOR TECHNOLOGIES CORPORATION, Aliso Viejo, CA (US)

(21) Appl. No.: 14/136,312

(22) Filed: Dec. 20, 2013

(30) Foreign Application Priority Data
Dec. 21, 2012 (IN) 3981/DEL/2012

(51) Int. Cl. B05B 13/06

(52) U.S. Cl. CPC B05B 13/0618
USPC 118/708; 118/712; 118/620; 118/641; 118/306; 118/75

(57) ABSTRACT

An in situ apparatus, system, and method for cladding or repairing cladding in installed pipelines are presented. The apparatus can include a coating collar, a material reservoir, a cladding head, an adjustable cladding chamber, and a chamber controller. The coating collar can include an external surface, a first circumferential wall, and a second circumferential wall and forms the adjustable cladding chamber along with interior wall of the pipe. The coating collar can have an aperture to include and allow deployment of the cladding head through it. The cladding head can be operatively coupled with the cladding material reservoir to allow efficient deployment of the cladding material on the pipe surface. The chamber controller can be coupled with the adjustable cladding chamber to control dimensions of the chamber thus restricting and controlling the environment and enabling efficient functioning of the cladding head and limiting grain growth in applied nanoclad materials.

This application claims priority to Indian Application 3981/DEL/2012 filed on Dec. 21, 2012. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is pipe weld repair technologies.

### BACKGROUND

Pipelines are often used for transporting fluids or gaseous materials from one location to another and therefore vary in their structure and function based on their industrial applicability. Based on the technology industry such as oil, liquefied gas, natural gas, water or other civil or such industries, for which the pipeline is to be used, the type of pipe, size, length, material of construction, or diameter of the pipe can be varied. For instance, metal pipes can be used in various civil or industrial applications for safety and better performance over its lifetime. Further, pipelines can be laid over a long distance to transport the materials from one location to another. As a single pipe of such a length cannot be manufactured or deployed, multiple pipes are typically manufactured and welded together, forming a continuous pipeline that can be laid in its required position and can be used for its intended industrial application.

Cladding process can be performed to make sure that the joint formed between two pipes does not allow any leakage of the material supplied through the pipe. These joints should not contain any unevenness, grain formation, holes or breakages. Utmost care should be taken while forming joints from cladding so that any leakage due to corrosion or breakage does not occur. A number of cladding apparatus and methods are used in the industry to improve the efficiency of cladding process and to improve the quality of clad formed on the substrate. One example of the issues associated weld repair is that when a nanoclad interior surface is heated in the vicinity of the weld, the nanomaterial experiences grain growth. Such grain growth can diminish or destroy the beneficial properties for which the nanomaterial was intended to provide, especially at a highly vulnerable failure location, the weld.

U.S. patent application 2009/0307891 to Offer et al. titled “Method and apparatus for remotely inspecting and/or treating welds, pipes, vessels and/or other components used in reactor coolant systems or other process applications”, filed Jun. 17, 2008, discloses a tool for remote inspection and/or treatment of welds, pipes vessels and/or other components. The tool proposed by Offer is placed at the entrance to a pipe and walks through a pipe to a pre-selected weld and anchors itself to the location. The tool then inspects or treats the pre-selected weld. Offer merely allows the tool to be moved inside the pipe to a desired location but does not provide flexibility of choosing the surface area on which cladding is to be performed and also does not allow the tool to be adjusted in terms of its dimensions such that a restricted cladding environment is created.

U.S. Pat. No. 5,345,972 to Goglio et al. titled “Method for repairing local damage to pipelines by applying cladding with an interposed protective sheath”, filed Mar. 16, 1993, discloses a method for repairing local damages formed on a pipeline by applying cladding that consists of two cylindrical half shells welded together forming an interspace, applying gaskets on the edges on the cladding formed on surface of the pipe, and injecting resin into the interspace of the cylindrical half shells.

WIPO publication 1997/041994 to Pirl et al. titled “Apparatus and method for laser welding the inner surface of a tube”, filed Apr. 29, 1997, discusses an apparatus and method for laser welding an inner surface of a tube comprising a laser head for rotatingly projecting laser beam on the surface of the pipe to form a weld zone. Pirl further discloses filling weld material prior to projecting laser beam and feeding the weld material to the weld zone during projecting laser for welding.

WIPO publication 2000/021710 to Offer et al. titled “Method of applying a corrosion resistant cladding”, filed Oct. 13, 1998, discusses a method of welding cladding to a surface of a metal component of a nuclear reactor at a region susceptible to stress corrosion cracking. The disclosure of Offer does not provide flexibility of choosing the surface area on which cladding is to be performed and also does not allow the tool to be adjusted in terms of its dimensions such that a restricted cladding environment is created. The mechanism for movement of the apparatus within the installed pipe, as discussed by Offer, is also not efficient.

The above discussed materials merely disclose welding or cladding apparatuses but do not solve the need of cladding for already installed (in-situ) pipes. Existing solutions also make the cladding apparatus rigid and not flexible enough to move across the portions or segments of the pipe. Existing cladding solutions also do not cater to the need of adjusting the dimensions of the cladding apparatus so that a restricted cladding environment can be created for efficient, consistent, or continuous deployment of the cladding material.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for an in situ cladding apparatus and a method of application thereof that can allow efficient transportation of the cladding apparatus from one location of the pipe to another, and effective, consistent, or controlled deployment of the cladding material.

### SUMMARY OF THE INVENTION

The inventive subject matter provides an in situ apparatus for performing cladding in installed pipelines, pipes, vessels, or other like materials and also provides a method of application or use of the apparatus. The apparatus can be configured to move along the interior of the pipe through a transport module allowing cladding of defects in welds or other portions of the installed pipes at varied locations. One aspect of the inventive subject matter includes an in situ apparatus for cladding within an installed pipe, pipeline, vessels, among other such devices having joint surfaces, where the apparatus can include a coating collar, at least one cladding material reservoir, a cladding head, an adjustable cladding chamber, and a chamber controller.

The coating collar can include an external surface, a first circumferential wall, and a second circumferential wall, placed on internal surface of the pipe wall on which cladding is to be performed. The adjustable cladding chamber, as a whole, can be defined or formed by the coating collar and the internal surface of the pipe wall such that dimensions of the chamber can be changed based on parameters including surface area to be covered for cladding, location of cracks, or severity of cracks, among other such parameters. In structure, the adjustable cladding chamber can be formed from the interior wall of the pipe, the external surface of the collar, the first circumferential wall, and the second circumferential wall of the collar, thereby forming a chamber that is covered from all four sides. The coating collar can include an aperture to include and allow deployment of the cladding head through it. The cladding head can be operatively coupled with one or more cladding material reservoirs to allow flow of the cladding material through the cladding head.

Chamber controller can be configured to be operatively coupled with the adjustable cladding chamber to control dimensions of the chamber by controlling position of one or more of external surface of the collar, first circumferential wall, or second circumferential wall of the collar. Control of the dimensions of the adjustable cladding chamber allows for creation of and enablement of a restricted and controlled cladding environment, making the functioning of the cladding head efficient. In operation, position of the coating collar can first be positioned at a suitable or desired location on internal wall of the pipe, after which the chamber controller can control the dimensions of the adjustable chamber such as reducing or increasing the distance between the first and second circumferential walls. Once adjusted, the coating collar can allow cladding material from the cladding material reservoir to be deployed on the interior surface the pipe on which cladding is desired to be performed.

Apparatus of the present inventive subject matter can include a transport section that uses any of a horizontal or vertical transport method such as wheels, tracks, or combination of both, towed or cable suspended and the like for transporting the coating collar, and optionally the cladding material reservoir or the cladding head.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic cross sectional view of a cladding system comprising pipes, a transport module, a cladding apparatus, a power source, and a remote control interface.

FIG. 2 is a schematic magnified cross sectional view of a cladding apparatus.

FIGS. 3a and 3b are schematic cross sectional views of a cladding apparatus showing width and height adjustment of coating collar.

FIG. 4 is a schematic side view of a cladding system showing annulus straddling area.

FIG. 5 is an example method of cladding in pipes using a cladding apparatus.

### DETAILED DESCRIPTION

It should be noted that while the following description is drawn to nanoclad pipe weld repair systems and methods, various alternative configurations are also deemed suitable and may employ various modules including cables, antennas, dryers or other cladding devices operating individually or collectively.

One should appreciate that the disclosed system and method provide many advantageous technical effects including formation of uniform, even, and efficient clad on pipe joints within a controlled and adjustable cladding chamber. The disclosed system and methods also allows efficient transportation of cladding apparatus from one location of a pipe to another, allowing effective, consistent, or controlled deployment of cladding material.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The following discussion describes the inventive subject matter with respect to performing cladding in installed pipelines, pipes, vessels, or other like materials using an in situ apparatus. One skilled in the art will recognize that the inventive subject matter can scale as necessary to any number of items without departing from the inventive subject matter.

The following discussion uses words “nanoclad”, “clad”, and “cladding” repeatedly for easy understanding of the invention. The words “nanoclad” and “clad” refer to the same layer of material formed on the pipe surface for joining or curing defects. One skilled in the art will recognize that using “nanoclad” or “clad” for cladding material can indicate same function or purpose and therefore have been used interchangeably without departing from the inventive subject matter.

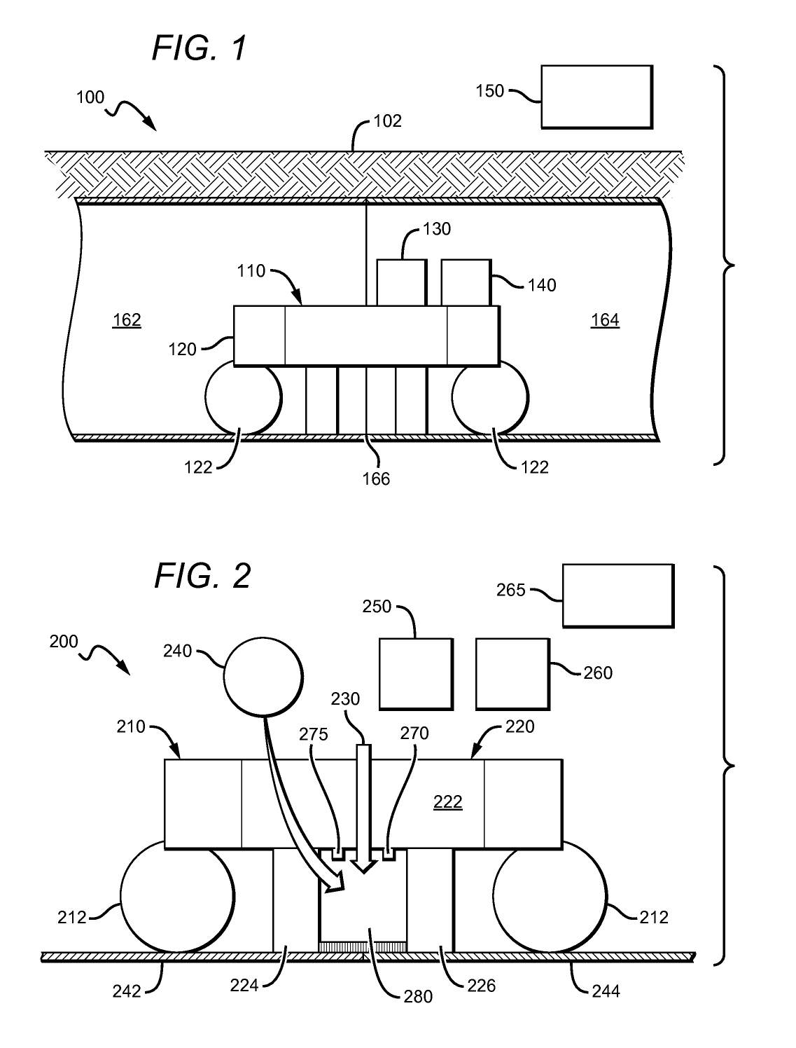

In FIG. 1, an in situ nanoclad pipe weld system 100 comprises a nanoclad pipe weld apparatus 110, a transport module 120, a power source 130, a chamber controller 140, and pipes 162 and 164 on which the cladding is to be performed. The pipes 162 and 164 of the system 100 can either already be installed in a pipeline network or can be due for installation. Such pipes can be configured to allow flow of liquid, gases, slurries, powders, or other flowable materials through them and can be present either below the surface of earth 102 or above the ground so as to enable transportation of specific material from one location to another location. The pipes can be used in applications such as oil and gas refineries, water supply system, chemical material supply system, transport of heavy water in nuclear reactors, among such other applications and can be made of steel, pig iron, or any other composition suitable for transportation of the desired material. As, with time, pipes typically develop defects in terms of cracks, leakage, or flaws in their joints, cladding is required for covering such cracks or other defects with a protective layer of cladding material.

In situ nanoclad pipe weld apparatus 110 can be configured for perform the cladding operation on portion 166 (e.g., seam, joint, etc.) joining the inner walls of the pipes 162 and 164. The apparatus 110 can have access to cladding material from a cladding material reservoir, where the cladding material can be used along with one or more heat sources to clad the desired portion of the pipes. Such heat sources can include a laser, a torch, polarized light, high frequency arc weld, a fusion lamp, or other suitable energy source. Apparatus 110 can be transported from one location along the interior portion of the pipe to another location through the transport module 120 to perform cladding at a required location by forming an annulus straddling area and spraying cladding material in the same. The transport module 120 can enable movement of the apparatus 110 using wheels or tracks 122 or other such transport mechanisms.

In situ nanoclad pipe weld apparatus 110 can be powered through power source 130. The power source 130 can either be external to the apparatus 110 or within it and can be configured to power operations of the apparatus 110 or power operation of the chamber controller 140. The power source 130 can also be configured to provide power to the transport module 120 for transporting the apparatus 110 to a desired location to perform cladding. Instead of a single power source 130, two or more of such sources can also be used for separate power supplies for the apparatus 110 and the transport module 120. Example power sources can include batteries or externally generated power supplied to apparatus 110 via a cable.

Chamber controller 140 can be configured to control the operation or dimensions of the cladding chamber within apparatus 110 such as width or height of the chamber walls so as to allow a restricted cladding environment to be created for efficient, consistent, or continuous deployment of cladding material at defective portions of the pipe. The cladding chamber can be defined by various elements of apparatus 110 as well as the interior walls of pipes 162 or 164. Chamber controller 140 can be operatively coupled with a remote control interface 150 to enable a user to remotely control the movement, operation, dimensions, or cladding characteristics of the apparatus 110. The nanoclad pipe weld apparatus 110 has been described in detail with reference to FIG. 2.

FIG. 2 illustrates a nanoclad pipe weld apparatus 200 (not drawn to scale) comprising a coating collar 220 configured on a specific portion of pipes 292 and 294 that need to undergo the cladding operation. Coating collar 220 can have an external surface 222, a first circumferential wall 224, and a second circumferential wall 226. As the walls 224 and 226 can be designed in multiple dimensions or configurations, they would be referred to as first wall 224 and second wall 226 hereinafter. Apparatus 200 can further include an adjustable cladding chamber 280, formed by positioning first wall 224 and second wall 226 against the interior surfaces of pipes 292 and 294. External surface 222 can also comprise a boundary of chamber 280. One should appreciate, as illustrated, cladding chamber 280 can form an annular or toroidal chamber. In some embodiments, chamber 280 can be further restricted by including additional walls (not shown) so chamber 280 comprises an arcuate portion of a torus.

In operation, coating collar 220 forms the main body of the nanoclad pipe weld apparatus 200. The coating collar 220 can initially be placed at a desired location along inner walls of the pipes 292 and 294 to perform cladding. The external surface 222, first wall 224, and the second wall 226 can be adjusted such that when the coating collar 220 is position with respect to the internal walls of the pipes 292 and 294, the first wall 224 and the second wall 226 fit snuggly on the inner walls of the pipes. The first wall 224 and the second wall 226 of the coating collar 220 can therefore be selected and adjusted based on the circumference or annularity of the inner walls of the pipes 292 and 294. With an increase in the circumference of the inner walls of the pipes, circumference of the base of the first wall 224 and of the base of the second wall 226 that touch the surface of the pipes 292 and 294 can also increase such that no gap is formed between the inner walls of the pipes and the walls of the coating collar 220. First and second walls can also be configured such that they are retractable within the collar 220. Thus, first wall 224 and second wall 226 are adjustable under command of chamber controller 260. First wall 224 and second wall 226 can be individually moved parallel to pipes 292 and 294 (e.g., axially or longitudinally) or can be individually extended to or retracted from the surface of pipes 292 and 294 (e.g., radially).

External surface 222 of the coating collar 220 can be configured on the first wall 224 and the second wall 226, thereby forming an upper wall of the coating chamber 280. The external surface 222 can provide support to the first wall 224 and the second wall 226 so as to reside on the inner walls of the pipes 292 and 294. The external surface 222, the first wall 224, and the second wall 226 complete the coating collar 220 and can provide a platform to perform cladding on the inner surface of the pipes 292 and 294. The external surface 222 can have a circumferential structure so as to fit with the first wall 224 and the second wall 226. In other embodiments, the external surface 222 can also have a longitudinal or any other desired structure. One should appreciate that cladding chamber 280 can include additional boundaries; additional walls for example, to ensure the dimensions of chamber 280 have desirable characteristics.

The external surface 222, the first wall 224, and the second wall 226 of the coating collar 220 can be made of materials such as steel, cast iron, other metal alloys, among other such materials that are robust against the cladding process. The surface 222 and the walls 224 and 226 can be made of different or same material. Material configuration of the external surface 222 and the walls 224 and 226 can be selected and adjusted based on the pipes 292 and 294 and the industrial application for which they are used.

Cladding apparatus 200 can include a cladding head 230 configured to assist in the cladding process by acting as a source of laser, torch, polarized light, high frequency arc weld, fusion lamp, among other such sources to melt cladding material originating from cladding material reservoir 240 and allowing the melted cladding material to be placed on the desired portion of pipes 292 or 294. External surface 222 of the coating collar 220 can include one or more apertures or through-holes (not shown) that can allow the cladding head 230 to penetrate through the external surface 222 and allow deployment of the cladding head 230 and related cladding material. The apertures can be designed such that the amount of cladding material to be laid on the inner walls of the pipes is appropriate and controlled, possibly via controller 260. Dimensions of the aperture can be configured based on the dimensions of the cladding head 230, and can be varied based on user required dimensions of clad to be formed on the inner walls of the pipes 292 and 294.

The cladding head 230 can be aligned and deployed through one of the apertures of the coating collar 220, where the cladding head 230 passes through the aperture present on the external surface 222 and extends towards the inner walls of the pipes 292 and 294. In operation, the cladding head 230 can be configured to generate sufficient heat near the surface of the pipes 292 and 294 where joint is to be formed to perform cladding such that the cladding head 230 along with the cladding material forms the clad on the surface of the pipes 292 and 294.

The nanoclad pipe weld apparatus 200 can include cladding material reservoir 240 for storing the cladding material that is to be added on the inner walls of the pipe 292 and 294 to perform cladding. The cladding material reservoir 240 supplies the cladding material to the location where cladding is performed on the surface of the pipes 292 and 294 through an aperture in the external surface 222. In some embodiments, the cladding material reservoir 240 can be coupled with the cladding head 230 via a dispenser before passing through the aperture of the external surface 222 and the cladding material can be sprayed on the surface of the pipes 292 and 294 along with cladding head 230.

Cladding material used for cladding can be in powder, liquid or gaseous state. The cladding material can include resins, copper-clad steel, copper-clad aluminum wire, EN72 nickel chrome alloy, among other like materials. Resin material can include liquid epoxy resins in combination with an amine-type hardener, or acrylic, vinyl or allyl liquid monomers in combination with a polymerization catalyst, normally chosen from organic percarbonates, peroxides and hydroperoxides. In some embodiments finely divided inert inorganic materials such as powdered marble can also be added to the materials to increase the strength. It should be appreciated acceptable materials also include custom designed nanocladding materials consistent with those selected for use generally in the cladding of the piping system or nanocladding materials custom selected for repair or custom protection of the welds. Thus, contemplated system can employ one or more types of cladding material to a target point. For example, one type of cladding material and be deposited to the piping system before field welding and a second, possibly stronger material, can be applied to the resultant welds to reduce risk of weld failure below the risk of general piping system failure.

Pipe weld apparatus 200 can further include an adjustable cladding chamber 280 formed by the inner walls of the pipes 292 and 294, the external surface 222, the first wall 224, and the second wall 226 of the coating collar 220. The adjustable cladding chamber 280 forms a region where the cladding head 230 and the cladding material from the cladding material reservoir 240 can be melted, forming the cladding on the surface of the pipes 292 and 294. Dimensions of the adjustable cladding chamber 280 can be adjusted by vertically (with respect to the figure orientation; radially with respect to pipes 292 and 294) adjusting the external surface 222, or horizontally (with respect to the figure orientation; axially along the length of pipes 292 and 294) adjusting the first wall 224 or the second wall 226 of the coating collar 220 to obtain cladding of required dimensions and restricting the portion on which the cladding is to be performed. For instance, for obtaining cladding on a small portion of the pipe, width between the first wall 224 and the second wall 226 can be reduced along with reduction in the height of the external surface 222 with respect to the pipes 292 and 294. Reduction in the height of the external surface 222 allows a thin layer formation of the cladding material on the pipes. Likewise, for obtaining cladding of various dimensions or over varied sizes of pipe portions, dimensions of the external surface 222, the first wall 224 and the second wall 226 of the coating collar 220 can be adjusted with respect to the internal walls of the pipes 292 and 294 to enable a restricted and efficient application of cladding material.

Adjustable cladding chamber 280 formed by the external surface 222, the first wall 224, and the second wall 226 of the coating collar 220 along with the internal walls of the pipes 292 and 294 can also be configured as an open chamber, which can be opened at any two adjacent sides of the first wall 224 and the second wall 226. This can allow the cladding to be performed in an open adjustable cladding chamber 280 if required. Apart from vertical movement, external surface 222 can also be configured to move in different directions or along multiple axes under command of chamber controller 260. Similarly, apart from horizontal moment, the first wall 224 and the second wall 226 can also be configured to move in other directions or along multiple axes. Suitable open or closed adjustable cladding chamber 280 having desired dimensions and constructional features can therefore be selected for performing cladding based on the function or structure of pipes 292 and 294, cladding material used for performing cladding, or type of the cladding head 230. For example, some cladding materials can form oxidizing layers on the surface of the newly formed clad upon reacting with air when cladding is performed in open adjustable cladding chamber 280, thereby reducing the quality and life of the clad. For such kind of cladding therefore, closed adjustable cladding chamber 280 can be configured to avoid reaction between air and the cladding material for improving quality and life of the clad. Further, chamber 280 can move along with cladding head 230 to create a moving cladding environment. For example, chamber 280 and head 230 can rotate circumferentially around the seam between pipes 292 and 294 to clad the entire seam.

The adjustable cladding chamber 280 along with pipes 292 and 294 can form an annulus straddling area on the pipe surface on which the cladding head 230 receives the cladding material from the cladding material reservoir 240 and performs cladding on the surface joints of the pipes 292 and 294. The annulus straddling area can be configured as the only region in the adjustable cladding chamber 280 where the cladding material can be sprayed and the cladding can be performed. As the adjustable cladding chamber 280 can be adjusted to define or limit the area of cladding application or repair, width of the annulus straddling can be defined to reflect the area that would be affected by heat of welding to the extent that such the heat results in potentially unacceptable grain growth in the cladding material.

Pipe weld apparatus 200 can further include a chamber controller 260 for controlling dimensions of the adjustable cladding chamber 280. The chamber controller 260 can include a processor or a microcontroller for controlling the dimensions of the adjustable cladding chamber 280. The chamber controller 260 can control the width or height of the adjustable cladding chamber 280 by controlling the external surface 222, the first wall 224, or the second wall 226 of the coating collar 220 for performing cladding on the surface of the pipes 292 and 294 according to desired requirements.

Chamber controller 260 can be attached on the external surface 222 of the coating collar 220 to control the adjustable cladding chamber 280. In an embodiment, the chamber controller 260 can be present at a remote location away from the adjustable cladding chamber 280 and configured to control the adjustable cladding chamber 280 from the remote location itself. In yet another embodiment, the chamber controller 260 can be present within the apparatus 200 and operatively coupled with a remote control interface 265, as explained in FIG. 1, where a user can use the remote interface 265 to control or issue instructions to the controller 260, which in turn controls the dimensions, operations, or other characteristics of collar 220 or adjustable cladding chamber 280. The chamber controller 260 can be a wired or wireless controller. The chamber controller 260 can be configured to adjust dimensions of the cladding chamber 280 as a function of the cladding data, wherein the cladding data can be stored in the controller itself.

The remote control interface 265 can be configured with a display that shows the location of the coating collar 220, configuration settings of the collar 220, amount of cladding done/left, among other cladding attributes that can help the user to control the chamber controller 260 such that the cladding operation can be appropriately undertaken. The remote control interface 265 can also display warning messages to user in case of any errors occurring during cladding or issue specific instructions to the chamber controller 260 to take prompt actions for controlling the cladding procedure.

The apparatus 200 can further include one or more cladding sensors 270 for sensing the amount of cladding material laid on the surface of pipes 292 and 294 or for measuring the level of cladding that has been performed. The cladding sensors 270 can be coupled with the chamber controller 260 for gathering cladding data representative of the cladding location and providing gathered data relating to cladding status to the chamber controller 260, based on which the controller 260 can take further actions for cladding the surface of the pipes 292 and 294. Information provided by the cladding sensors 270 can also be useful in adjusting the dimensions of the coating collar 220 and determining the quantity of cladding material being laid on the surface of the pipes 292 and 294. In an embodiment, cladding sensors 270 can be transceiver type sensors comprising a transmitter for transmitting signals to the chamber controller 260 indicating the level of cladding done in the adjustable cladding chamber 280 and to provide dimensional information to the chamber controller 260 and comprising a receiver for receiving information or instructions from the chamber controller 260. The cladding sensors 270 can also be coupled with the chamber controller 260 through wired connections. The cladding sensors 270 can include optical sensors, cameras, ultrasound sensors, magnetic sensors, chemical sensors, location sensors, gas sensors, temperature sensors, humidity sensors, pressure sensors, among other sensors. Such sensors allow apparatus 200 to operate as a well repair system, cladding system, or even an inspection system capable of monitoring a piping environment. For example, apparatus can utilize such sensors to determine pipe thickness, corrosion, temperature, humidity, nature of gases present (e.g., hazardous gases, inert gases, etc.).

One should appreciate that sensors 270, among other sensors, provide information to an operator possibly through the remote control interface 265. For example, a location sensor (e.g., GPS sensor, laser, wireless transmitter, acoustic transmitter, etc.) can provide an operator tracking information to ensure apparatus 200 is in correct location. Further, remote control interface 265 can provide visual, auditory, or other modalities of feedback to the operator possibly via suitable output interfaces (e.g., speakers, displays, force-feedback, etc.) integrated within remote control interface 265. One should further appreciate that apparatus 200 can also be instrumented with similar output interfaces, which can aid identifying or controlling apparatus before or during operation.

Number or location of cladding sensors 270 can be modified based on their requirement or type. In an embodiment, the cladding sensors 270 can be coupled on the inner walls of first wall or second walls 224 and 226, or on the external surface 222 of the coating collar 220. For instance, only a single cladding sensor 270 can be used on any of the walls or surfaces. Such sensors 270 can either be affixed on the outer surfaces of the walls or the inner surfaces of the collar 220, and apart from examining the level and quantity of cladding, can also be configured to measure the quality of cladding in terms of evenness, thickness, flow pattern, among other such qualitative parameters. Various other sensors can also be incorporated within the apparatus 200 for measuring and providing information about various parameters of the cladding formed on pipes 292 and 294. For instance, a temperature sensor can be used in the apparatus 200 for measuring the temperature in the adjustable cladding chamber 280, a pressure sensor can be configured to measure the pressure in the adjustable cladding chamber 280, and an alignment sensor can be configured to monitor the alignment of the cladding formed on the pipes 292 and 294.

The apparatus 200 can further include a cooling element 275 for cooling the cladding formed on the annulus straddling area on the pipes 292 and 294. The cooling element 275 can spray or deposit an appropriate coolant on the newly formed cladding to control the heat of the cladding and to make the clad hard and dry, thereby ensuring quick and easy formation of clad. The cooling element 275 can be positioned on any portion of the coating collar 220. Use of the cooling system aid in addressing the issue where a nanoclad interior surface is heated, causing undesirable grain growth. Thus, the disclosed techniques providing for limiting grain growth, which aids in mitigating risk of failure at a vulnerable point of failure.

The area can also be pre-cooled in the case where photonic driven vapor deposition of a nanoclad material is used or other comparable material deposition technology. In this instance the surface exposed to the high temperature light reaches a temperature that fuses a vaporized material in the annulus to the pipe and weld area but the propagation of the heat wave potentially causing unwelcomed grain growth in surrounding clad material is attenuated through the pre-cooling. Thus the effect of the cooling in nanomaterial depositions is to limit grain growth and associated lessening of material properties inside the annulus region but also to limit the propagation of the heat wave outside the annulus impacting any previously applied clad. Further, in view that the cladding chamber environment can be control, one should appreciate that weld area can be pre-cooled, post-cooled, pre-heated, or post-heated as desired or required for the cladding. For example, in some embodiments heating can be used to relieve internal stresses within the weld area.

The cooling element 275 can also be controlled by the chamber controller 260, wherein the controller 260 can receive data from the cladding sensors 270 about formation of cladding in the annulus straddling area and upon receiving the data regarding formation of cladding, the chamber controller 260 can instruct the cooling element 275 to spray coolant on the newly formed clad.

In an embodiment, the coating collar 220 can be transported to a desired location within the pipes 292 and 294 for performing cladding using a transport module 210. Along with the coating collar 220, other elements of the apparatus 200 such as cladding material reservoir 240, chamber controller 260, among others can also be moved from one location to another. The transport module 210 can move the coating collar 220 either horizontally or vertically or along another desirable axis. The transport module 210 can include a base on which the coating collar 220 along with other elements of the apparatus 200 can be mounted. The module 210 can further include two or more wheels 212 at opposite ends of the base, which can help move the collar 220 along the inner walls of the pipes 292 and 294 to the required location. It should be appreciated that apart from wheels, other commonly used transportation mechanisms such as tracks, tows or cables, axles, springs, hydraulic arms, or combinations thereof can also be used. The transport module 210 can also be configured to transport the apparatus 200 radially along the inner walls of the pipes 292 and 294, wherein the radial movement can be carried out in conjunction with horizontal and vertical movement.

A power source 250 can be used to provide power to the transport module 210 for transporting the apparatus 200 or the coating collar 220 to a desired location to perform cladding. Furthermore, same or an independent power source 150 can also be configured to provide power to the chamber controller 260 for controlling the dimensions of the adjustable cladding chamber 280 by controlling the width and height of the external surface 222, the first wall 224, or the second wall 226 of the coating collar 220 and thereby controlling the area on which or the extent to which the cladding is performed on the surface of pipes 292 and 294. The power source 250 can also provide power to the cladding sensors 270 or to the cladding head 230 for converting electrical energy and generating sufficient heat energy to form the cladding on the surface of the pipes 292 and 294 using the cladding material from the cladding material reservoir 240.

Power source 250 can be used to power various other modules of the apparatus 200 or the transport module 210 and can be configured to give AC power, DC power, or stored energy such as through battery, and the like. The power source 250 can be present along with the apparatus 200 on the transport module 210 and can be transported to the desired location to provide power at the required location. In some embodiments, the power source 250 can be present at a remote location from the apparatus 200 and the transport module 210 and configured to provide power through direct lines.

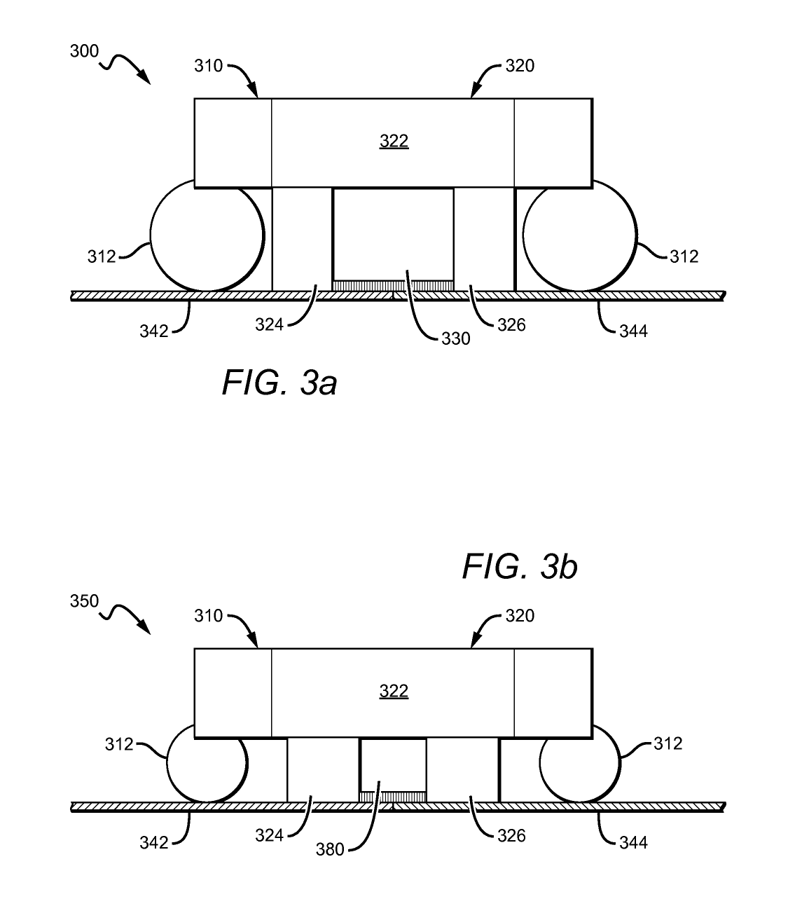

FIGS. 3a and 3b are schematic cross sectional views of cladding apparatus 300 and 350 showing width and height adjustment of coating collar 320. Apparatus 300, as shown in FIG. 3a, includes a coating collar 320 positioned on a desired location between pipe sections 342 and 344 on which cladding operation needs to be performed. The coating collar 320 includes an external surface 322, a first wall 324, and a second wall 326, which along with the interior wall of the pipes 342 and 344 form an adjustable cladding chamber 330 where chamber 330 has been adjusted to have wide coverage over the seam between pipes 342 and 344. Apparatus 300 further includes a transport module 310 having wheels or other movement enabling mechanisms 312.

Similarly, the apparatus 350, as shown in FIG. 3b, includes a coating collar 320 positioned on a desired location between pipe sections 342 and 344 on which cladding operation needs to be performed. The coating collar 320 includes an external surface 322, a first wall 324, and a second wall 326, which along with the interior walls of the pipes 342 and 344 form a new adjustable cladding chamber 380 of different dimensions than cladding chamber 330; in this case cladding chamber 380 has smaller dimensions that the original chamber 330. Apparatus 350 further includes a transport module 310 having wheels or other movement enabling mechanisms 312.

As described above, the adjustable cladding chambers can be changed in dimensions so as to allow the cladding operation to be performed on a desired area or section of the pipes by creating a restricted environment accessible to cladding head. Changing the dimensions also helps configure the extent of cladding to be performed including controlling the thickness or width of the clad. Such adjustment in dimensions can be done by controlling the position of at least one of the external surface of the coating collar, the first circumferential wall, or the second circumferential wall relative to the interior wall of the pipe.

Coating collar 320 in FIGS. 3a and 3b show the adjustment in their dimensions to form different adjustable cladding chambers 330 and 380 respectively, where the collar 320 of FIG. 3a shows the chamber 330 in an expanded state with relatively large area on which cladding is to be performed, and collar 320 of FIG. 3b shows the adjustable chamber 380 in a contracted state. As can be seen, in FIG. 3b, the first wall 324 with respect to pipes 342 and 344 has been moved towards the right, and likewise the second wall 326 with respect to pipes 342 and 344 has been moved towards the left so as to reduce the width or area of the pipe on which the cladding is to be performed. Furthermore, in FIG. 3b, the external surface 322 has been moved downwards when compared with its position in FIG. 3a, allowing reduced thickness or more precise cladding to be performed with cladding head closer to the inner wall of the pipes 342 and 344.

It should be appreciated that even through the present disclosure is being described with reference to cladding operation, similar operations such as welding or bonding can also be performed using the in-situ apparatus of the present disclosure and therefore is well covered within the scope of the present disclosure. Welding, for instance, can be performed at joints between two pipes, cracks within a pipe, or for curing any other applicable defect such as weld seam between two sections of a pipe or a longitudinal weld, among other such defects. Further, although the disclosed subject matter is presented with respect to apparatus 300 being disposed internally to pipes 342 and 344, one should appreciate that apparatus having adjustable cladding chambers can be disposed externally to pipes 342 and 344 without departing significantly from the inventive subject matter.

Cladding chamber 380 provides a controlled environment for the cladding process or for other purposes. For example, once in a proper position chamber 380 can be adjusted to create a sealed environment. Once sealed, apparatus 350 could create a desired environment possibly by evacuating gases, forming a partial vacuum, purging or draining materials (e.g., water, oil, gases, slurry, powder, etc.), injecting desired gases (e.g., inert gases, etc.), establishing desired pressures or temperatures, or otherwise controlling the environmental properties within chamber 380.

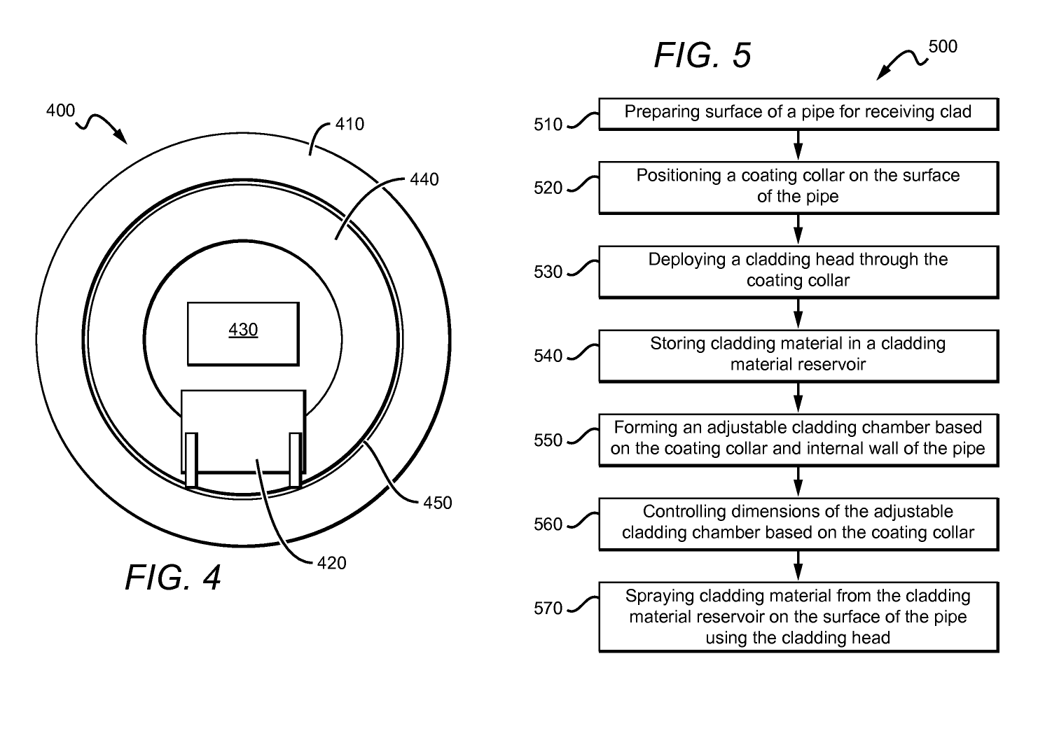

FIG. 4 is a schematic end-on view of a cladding system 400 showing annulus straddling area 450 on pipe 410 on which the cladding operation is performed. In the example shown, the view is presents of looking into an open end of pipe 410. The cladding system 400 includes a power source 430, a transport module 420, and a coating collar 440. The coating collar 440, with the help of the transport module 420, can be initially positioned at the portion of the pipe on which the cladding is to be performed, which portion can include two sections of a pipe, sections of two or more pipes, a longitudinal weld, and a defect or flaw, cracks, or unevenness in the inner surface of the pipe 410. Even though the present embodiment has been described with respect to cladding of sections of pipe 410, scope of the present disclosure can include handling of any possible defect including breakages that occur on inner walls of pipes, ships, gas chambers, and the like. The coating collar 440 can be placed on a section of the pipe 410 and the power source 430 can be configured to power other allied components such as chamber controller, sensors, among other parts of the cladding apparatus. The transport module 420 can move along the inner wall of the pipe 410 based on user's instructions and get powered from the power source 430. User can control the movement of the transport module 420 using a remote control interface or any other means by which the transport module 420 can be moved and stopped at desired locations. The transport module 420 can also be lifted, rotated or moved based on the location of the flaw identified on the pipe 410.

Once the transport module 420 halts at a particular location, the coating collar 440 can be moved close to the section of the pipe 410 where cladding is to be performed to remove the defect. In operation, inner wall surface of the pipe 410 can initially be treated before performing cladding to remove rough surfaces and old joint remaining, if any. Such treatment of the surface of the pipe(s) can be done by existing methods such as grinding, milling, polishing, among other such mechanisms. Cladding material can be deployed within the cladding chamber formed by coating collar 440 and the interior wall of pipe 410.

A cladding controller can control the dimensions of the adjustable cladding chamber formed by the interior wall of the pipe 410 and the coating collar 440 to allow configuration of the portion on which the cladding is to be performed or the extent of cladding to be done. First circumferential wall and second circumferential wall of the coating collar 440 can therefore be placed on the inner wall of the pipe 410 and can be adjusted to the circumference of the interior wall of pipe 410, such that no gap occurs between the walls of the collar 440 and the pipe wall. Height of the first circumferential wall and the second circumferential wall along with that of the external surface of the collar 440 can be adjusted by the chamber controller. The chamber controller can also control the distance between the first and the second circumferential walls, which impacts the width of the portion on which the cladding is to be done. The adjustable cladding chamber formed along with the pipe 410 can also form an annulus straddling area 450 for receiving the cladding. Width of the area 450 therefore reflects the area affected by the heat of the welding or cladding and can be changed by changing the dimensions of the collar 440.

Electrical energy can be supplied to the cladding head once the collar 440 has been adjusted on the desired portion of the pipe 410, upon which cladding material from the cladding material reservoir can be supplied along with the heat from the cladding head into the annulus straddling area 450. The cladding material present in the annulus straddling area 450 of the adjustable cladding chamber, upon receiving heat energy produced by the cladding head, begins to melt and forms a molten pool of clad on the surface of the pipe 410. The molten cladding begins to expand to occupy the annulus straddling area based on the dimensions of the adjustable cladding chamber. The first circumferential wall and the second circumferential wall can limit the width, and the external wall of the collar 440 can limit the height of the cladding formed in the adjustable cladding chamber or restrict the volume for vapor deposition.

As the molten cladding is disposed within cladding chamber, one or more chamber sensors measure the deployment of cladding formed in the adjustable cladding chamber and transmit a signal to the chamber controller informing that the cladding at the particular portion of the pipe has reached an optimum level. Upon receiving the signal from the chamber sensors, the chamber controller can initiate movement of the coating collar 440 along the circumference of the inner walls of the pipes to fill perform cladding at another desired location.

The cladding can therefore be performed in situ without repositioning the pipe 410 from its original location, thereby not disturbing the already installed pipe. Desired section of the pipe 410 on which the cladding is desired can be identified and cladding can be performed by calculating the dimensions of the cladding required to cover the section. Such calculation of the dimensions of the cladding to be performed can be done by a user or a computer to improve the efficiency of the process. The coating collar 440 can easily be moved around from one location to another using the transport module 420, leading to better performance of the cladding system 400. The adjustable cladding chamber can perform cladding in an efficient manner by adjusting dimensions of the collar 440 such that the cladding that is performed on the pipe surface is of high quality and has a long life. As the coating collar 440 controls the cladding performed in the annulus straddling area 450 and reduces formation of oxidation layer by reduction in involvement of air during operation, the cladding formed can be free from growth of unacceptable grains or grain growth, or other changes in clad material structure, leading to high quality cladding.

FIG. 5 presents a method 500 for performing cladding on welds or surfaces to repair cracks, flaws, leaks, or other defects in an in situ environment using a pipe weld apparatus of the pipe weld system. Even though the present embodiment has been described for cladding of inner walls of pipe joints, the present disclosure relates to curing of any defect in pipes, pipelines, vessels, or other such devices on which the instant subject matter can be applied.

Step 510 includes preparing surface of pipes for receiving cladding. Surface of pipes may contain unwanted materials such as rough surfaces from earlier welding, dust, oxidized layer formed due to oxidation of joint surfaces, among other such materials. Performing cladding on such unprepared surfaces can degrade the quality and reduce the life of the newly formed clad. Such surfaces can be prepared by removing oxidized layers, polishing the surface, scrubbing the rust or grains on the surface, among other common practices. Unwanted materials can be removed from the pipe surfaces by techniques such as milling, grinding, polishing, among other such common methods.

Step 520 includes positioning a coating collar on a desired portion of the pipe that is to undergo cladding. A transport module can allow movement of the coating collar to the desired portion of the pipe. Such movement of the coating collar can be horizontal, vertical, rotational, radial, longitudinal, or combination of the same. The transport module can use wheels, tracks, or combination of both, among other mechanisms such as hydraulics, cables and the like as the mode for enabling transportation. The transport module can move the coating collar along with interior wall of the pipe by using a power source. The coating collar can further be operatively coupled with a cladding head, a cladding reservoir, a cladding controller, or one or more cladding sensors.

Step 530 includes deploying a cladding head through one or more apertures of the coating collar. A suitable cladding head can be selected based on the type of cladding to be performed and can be configured to convert electrical energy into heat energy to perform the cladding operation. The cladding head can be deployed through an aperture present in external surface of the coating collar and can include a laser, a torch, polarized light, high frequency arc weld, a fusion lamp, among other such heat sources.

Step 540 includes storing cladding material in a cladding material reservoir. The cladding material reservoir stores the cladding material that is used for performing the cladding on the surface the pipes. The cladding material reservoir can be deployed through another aperture present in the external wall of the coating collar. In an alternate embodiment, the cladding material reservoir can be coupled to the cladding head before entering into the aperture of the coating collar and can be deployed through a single aperture of the collar. Cladding material reservoir can store cladding material in powder, liquid, or gaseous form and can be selected from resins, copper-clad steel, copper-clad aluminum wire, EN72 nickel chrome alloy, among other such materials. Resin material can be liquid epoxy resins in combination with an amine-type hardener, or acrylic, vinyl or allyl liquid monomers in combination with a polymerization catalyst, normally chosen from organic percarbonates, peroxides and hydroperoxides. Finely divided inert inorganic materials such as powdered marble can also be added to the cladding materials to increase their strength. All possible nanomaterials are contemplated.

Step 550 includes forming an adjustable cladding chamber based on the coating collar and the internal wall of the pipes. The cladding chamber can be covered from all four sides forming an enclosed area, where three sides can include two side circumferential walls of the collar and a top external surface of the collar acting as the top wall. The fourth side can include the internal wall of the pipe on which the cladding is to be performed. As three sides of the chamber are formed from the collar, the chamber can be adjusted in size and shape to allow a restricted environment to be created for the cladding process. The adjustable cladding chamber can be controlled by a chamber controller to allow the dimensions of the chamber to be changed at any time.

Step 560 includes controlling the dimensions of the adjustable cladding chamber by adjusting positions of the coating collar. Width and the height of the adjustable cladding chamber can be adjusted based on user requirement. For instance, for obtaining a thin or slim cladding, height of the external surface of the collar can be decreased and width of the first and the second walls can be reduced. The cladding can therefore be performed based on the width or severity of the crack or based on the amount of cladding required to sustain any material flow in the concerned pipe. An annulus straddling area can be formed in the adjusting cladding chamber with the joints of the pipes. The cladding controller controls the dimensions of the adjustable cladding chamber formed by the external surface, the first wall, and the second wall of the coating collar and the inner wall of the pipes.

Step 570 includes spraying or otherwise depositing the cladding material from the cladding material reservoir onto the surface of the pipe to form the clad; vapor deposition; and all other methods of depositing a cladding material onto the surface of a pipe. The power source can be configured to provide electrical energy to the cladding head and the cladding material reservoir. Further, cladding sensors present on the adjustable cladding chamber monitor the cladding formed on the surface of the pipes. In operation, the cladding material reservoir can initiate spraying of the cladding material on the surface of the pipes and simultaneously, the cladding head can receive electrical energy and generate heat energy to melt and form molten pool of cladding material. Continuous input of cladding material and heat generated can increase the clad formed on the pipe surface. Spread of the molten pool of cladding material can be controlled based on the dimensions of the cladding chamber. The cladding performed can fill the annulus straddling area of the adjusting cladding chamber to form a uniform and even clad on the surface of the pipes. The cladding sensors can accordingly transmit a signal to the chamber controller upon identifying that the cladding has reached an optimum level, in response to which the controller can instruct the coating collar to move to the next position of the pipe to perform cladding.

It should be appreciated that the present system, apparatus, and method for nanocladding of pipe welds can be used and implemented for any pipe, chamber, ship or marine vessel, refinery duct, among other such objects where cracks, rust, leakages, or other defects can cause danger, which need to identified or corrected.

It should also be appreciated that the disclosed apparatus can be considered a “smart pig” capable of offering additional services beyond providing a cladding environment. The disclosed apparatus can also be moved to specific locations to isolate an environment for other purposes, possibly including identifying a location or material, purging the environment, performing repairs, or other conducting other services. Consider a use case where the apparatus is positioned at a desired location within a pipe where a new instrument is to be installed (e.g., a valve, sensor, filter, fitting, or other item). Once in position, the apparatus establishes a desired chamber and seals the chamber. Externally, a worker can cut a hole into the pipe at the location of the chamber, likely between the walls of the chamber. The chamber's pressure can be adjusted to ease removal of the cutout as desired. The worker can then install a new feature into the hole (e.g., valve, filters, sensor, etc.) and weld it into place. When instructed, the apparatus can inspect the weld from inside the pipe, apply internal welds or cladding, or perform other action.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An in situ cladding apparatus for cladding within an installed pipe, the apparatus comprising:
a coating collar around a portion of a main body of the apparatus, the collar configured to allow deployment of a cladding head through the collar;
at least one cladding material reservoir capable of storing a cladding material coupled to the cladding head;
an adjustable cladding chamber formed from an interior wall of the pipe, an external surface of the coating collar, at least a first circumferential wall and a second circumferential wall extending away from the coating collar toward the interior wall;
a chamber controller configured to control dimensions of the adjustable chamber by controlling a position of at least one of the external surface of the coating collar, the first circumferential wall, and the second circumferential wall relative to the interior wall of the pipe; and
wherein under control of the chamber controller the adjustable cladding chamber substantially forms a restricted cladding environment accessible to the cladding head.

2. The apparatus of claim 1, wherein the first circumferential wall comprises an adjustable wall under control of the chamber controller.

3. The apparatus of claim 1, wherein the adjustable cladding chamber forms at least an arcuate portion of an annulus around the interior of the pipe.

4. The apparatus of claim 3, wherein the adjustable cladding chamber forms a complete annulus around the interior of the pipe.

5. The apparatus of claim 1, further comprising at least one cladding sensor capable of acquiring cladding data representative of a cladding location within the pipe.

6. The apparatus of claim 5, wherein the chamber controller is configured to adjust the chamber dimensions as a function of the cladding data.

7. The apparatus of claim 5, wherein the at least one cladding sensor includes at least one of the following: an optical sensor, an ultrasound sensor, a magnetic sensor, a chemical sensor, and a location sensor.

8. The apparatus of claim 1, wherein the cladding material reservoir is configured to store at least one of the following cladding materials: a powder, a liquid, and a gas.

9. The apparatus of claim 1, wherein the cladding location comprises a welding location.

10. The apparatus of claim 9, wherein the welding location comprises at least one of the following: a weld seam between two sections of pipe, a longitudinal weld, and a defect.

11. The apparatus of claim 1, further comprising a power source coupled with the cladding head and disposed within the collar.

12. The apparatus of claim 1, wherein the cladding head comprises at least one of the following:
a laser, a torch, polarized light, high frequency arc weld, and a fusion lamp.

13. The apparatus of claim 1, further comprising a transport module configured to move the adjustable chamber along an interior of the pipe.

14. The apparatus of claim 1, wherein the coating collar comprises a substantially cylindrical shape.

15. The apparatus of claim 1, wherein at least one of the first and the second circumferential walls are retractable within the collar.

16. The apparatus of claim 1, further comprising a remote control interface coupled with the chamber controller and responsive to signals from a remotely deployed remote control.

17. The apparatus of claim 16, wherein the remote control interface comprises a wireless interface.

18. The apparatus of claim 1, wherein the coating collar further comprises a cooling element.

19. The apparatus of claim 18, wherein the at least one of the circumferential walls comprises the cooling element.

20. The apparatus of claim 1, wherein the position comprises at least one of the following placements relative to the interior wall of the pipe: an angular placement, a longitudinal placement, a circumferential placement, and a radial placement.
